(19) United States
(12) Patent Application Publication
(10) Pub. No.: US 2014/0126210 A1
(43) Pub. Date: May 8, 2014

(54) ROTATABLE BULB

(71) Applicants: UNILED LIGHTING TW., INC., New Taipei City (TW); CHEER SHINE LIGHTING ENTERPRISES LTD., Yang Mei (TW)

(72) Inventor: Po-Cheng YANG, New Taipei City (TW)

(73) Assignees: CHEER SHINE LIGHTING ENTERPRISES LTD., Yang Mei (TW); UNILED LIGHTING TW., INC., New Taipei City (TW)

(21) Appl. No.: 13/669,755

(22) Filed: Nov. 6, 2012

(51) Int. Cl. F21V 21/00

(52) U.S. Cl. 362/249.03; 362/362; 362/375

(57) ABSTRACT

A rotatable bulb with single side illumination is disclosed, which includes a plastic housing 65; the plastic housing 65 in combination with a top portion of the lamp is made rotatably with reference to its lamp base 50. The plastic housing 65 has an axis tube 653 at bottom end; a spring metal 61 is configured on the axis tube 653 at an end; the spring metal 61 is electrically, elastically coupled against the metal screw 52 from inside.

### BACKGROUND

1. Technical Field

The present invention relates to a single side illumination light bulb, especially a bulb with an adjustment mechanism which makes the illumination direction of the lamp adjustable.

2. Description of Related Art

FIG. 1 is a prior art.

FIG. 1 shows a single side illumination light bulb which is disclosed by US patent no. 2009/0161354. It includes a first LED array (260) and a second LED array (250). A first heat sink (210) thermally attaches to the first LED array (260). A second heat sink (220) thermally attaches to the second LED array (220). An illumination direction is desired to be adjustable for some application. However, no disclosure any adjustment mechanism in the prior art which can be used to adjust the illumination direction of the lamp. An illumination direction adjustable mechanism for a single side illumination lamp is desirable to be created in the field.

### BRIEF DESCRIPTION OF THE DRAWINGS

FIG. 1 is a prior art.

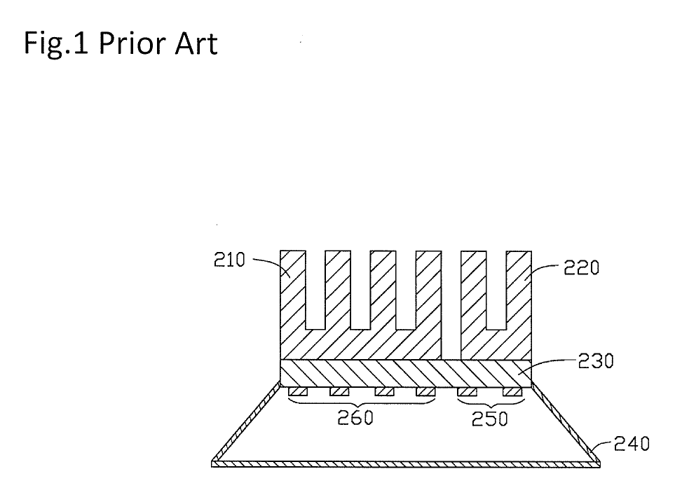

FIG. 2 is an exploded view of the present invention

FIG. 3 is a top portion of the lamp.

FIG. 4 shows the spring metal 61 configured on a cavity of the axis tube

FIG. 5A˜5B shows before and after mounting of the spring metal

FIG. 6 shows a complete lamp according to the present invention

FIG. 7 is a section view of the lamp of the present invention

### DETAILED DESCRIPTION OF THE INVENTION

This invention discloses a light bulb which has a single side illumination panel as a light source for the bulb. A light emitted diode matrix is configured on a top surface of the illumination panel. Further, the disclosed light bulb in this invention has a rotation mechanism which is devised for the user to adjust the illumination direction of the bulb so that the light beam is able to shed on a desirable direction.

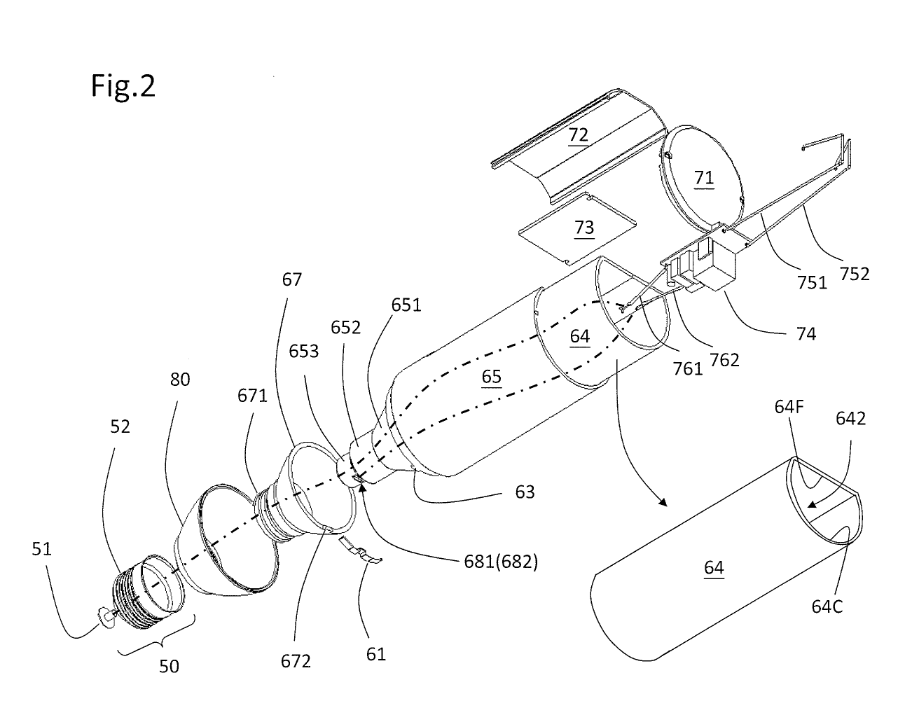

FIG. 2 is an exploded view of the present invention

FIG. 2 discloses a light bulb which includes a plastic housing 65; a tapered end 651 is extended from the plastic housing 65 at an end; a neck tube 652 is extended from the tapered end 651; an axis tube 653 is extended from the neck tube 652.

An inner trumpet 67 is rotatably mounted on the tapered end 651; an inner screw 671 is extended from the inner trumpet 67; a spring metal 61 is configured on the axis tube 653 at an end protruded from the inner screw 671.

An outer trumpet 80 is firmly fixed to the plastic housing 65 for holding the inner trumpet 67 and renders the inner trumpet 67 to be freely rotatable with reference to the plastic housing 65.

A lamp base 50 has a bottom metal 51 on the bottom as a first electrode and a metal screw 52 on the peripheral as a second electrode. The metal screw 52 is mechanically coupled to the inner screw 671 at an inner higher position. The metal screw 52 is electrically and rotatably coupled to the spring metal 64 at an inner lower position when the components have been assembled.

A metal tube 64 is composed of a flat metal 64F and a curved metal 64C; hollow space 642 is enclosed by the flat metal 64F and the curved metal 64C; a single side illumination panel 73 is configured on a top surface of the flat metal 64F; and the plastic housing 65 wraps over the outside surface of the curved metal 64C but exposes the outside surface of the flat metal 64F. The hollow space 642 communicates with the central passage 654 of the plastic housing 65.

A stopper bump 672 is configured on a ring fringe of the inner trumpet 67; and a position bump 63 is configured on a top surface of the tapered end 651; the position bump 63 is configured rotatably with reference to the stopper bump 672. A control unit 74 is housed in the hollow space 642; the control unit 74 is electrically coupled to the illumination panel 73 at one end; and electrically coupled to the spring metal 64 and the bottom metal 51 at the other end. A light cover 72 is configured on a top of the illumination panel 73 to diffuse or modify the light beam from the light emitted diodes before they emit out of the lamp. An end cover 71 is configured on an open end of the hollow space 642.

The control unit 74 has a first pair of lead 751, 752 at one end, and has a second pair of lead 761, 762 at a second end. The first paired lead 751,752 is electrically coupled to the illumination panel 73; and the second paired lead 761, 762 is electrically coupled to the electrode 51 and metal screw 52 respectively.

FIG. 2 shows a light emitted diode matrix configured on the top surface of the single side illumination panel

FIG. 2 shows that a light emitted diode matrix 731 is configured on a top surface of the single side illumination panel 73.

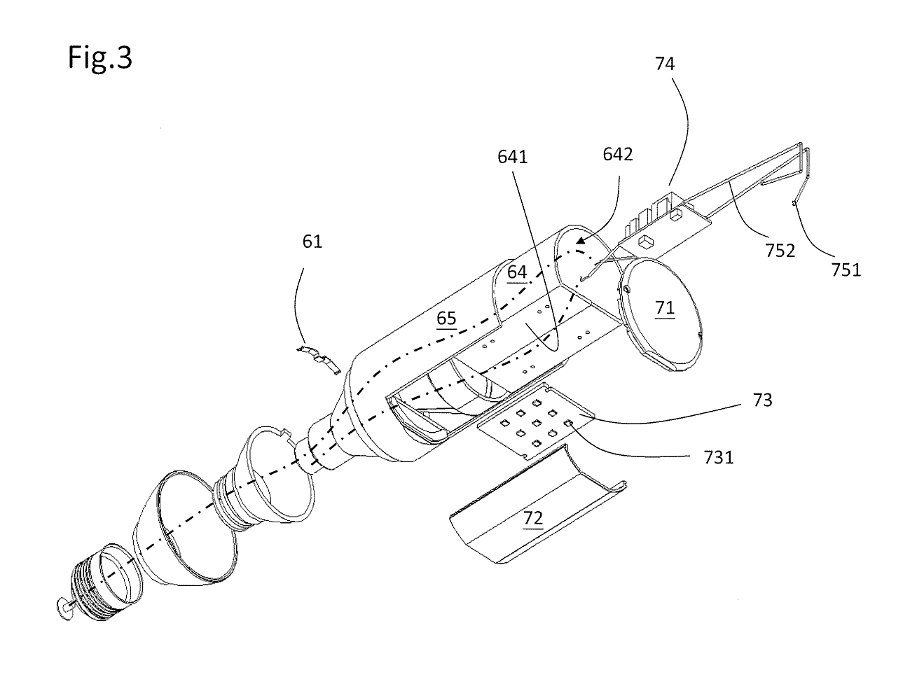

FIG. 3 is a top portion of the lamp.

A spring metal 61 is adapted to be configured in a cavity 681 at an end of the axis tube 653 exposed out of the inner screw 671. The spring metal 61 is electrically coupled to one electrode of the control unit 74.

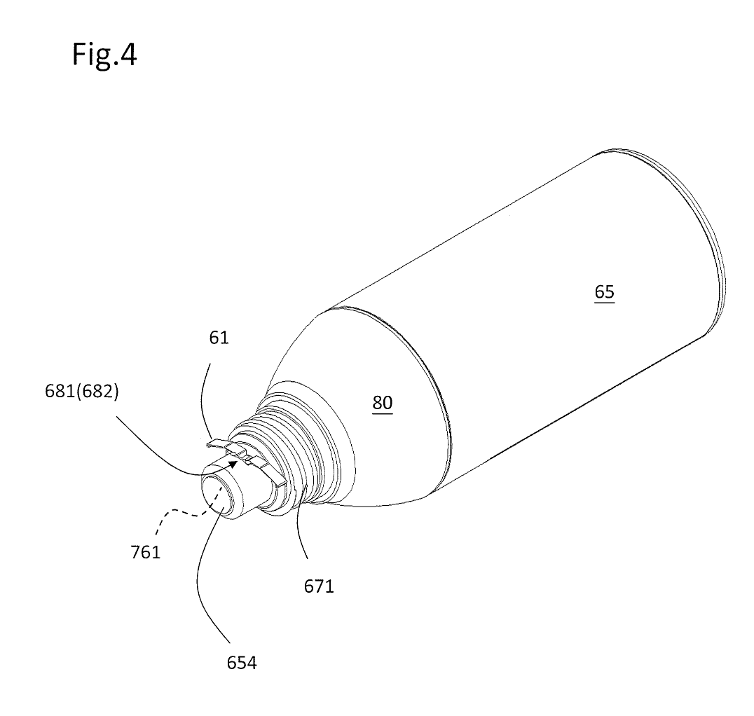

FIG. 4 shows the spring metal 61 configured on a cavity of the axis tube

FIG. 4 shows the spring metal 61 is configured in the cavity 681. One of the leads from the control unit 74, travelling in the central passage 654 of the lamp is electrically coupled to the spring metal 61 from the backside of the spring metal 61. One of the leads 761 from the control unit 74 traveling through the central passage is adapted to be electrically coupled to the electrode 51. The plastic housing 65 has a central passage 654 which communicates with the hollow space 642 upward and communicates with the inner space of the lamp base 50 downward.

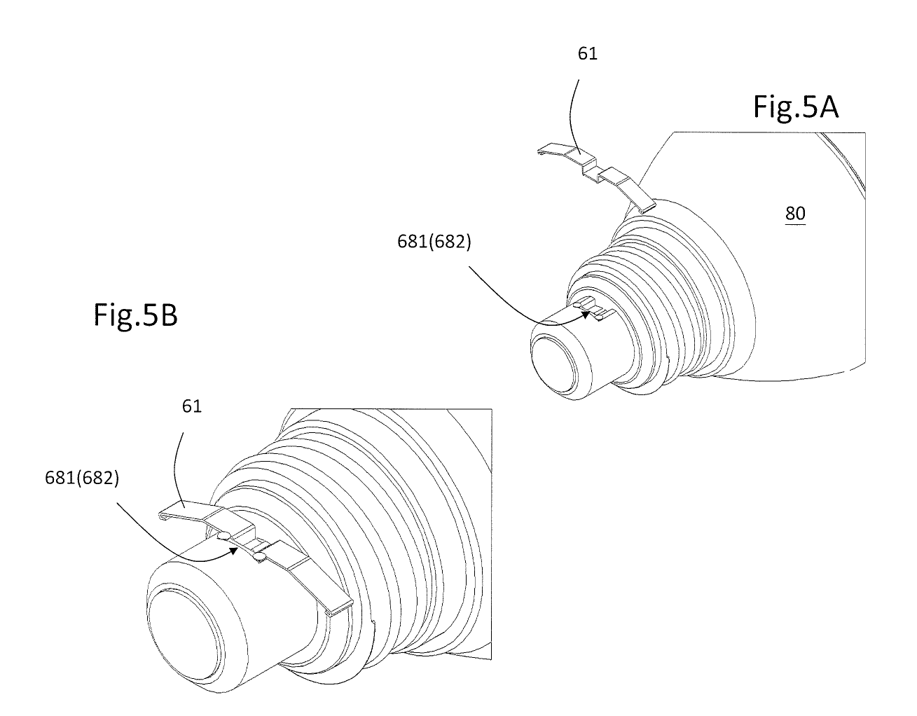

FIG. 5A˜5B shows before and after mounting of the spring metal

A cavity 681 is configured in the axis tube 653 at an end. A metal seat 682 is configured in the cavity 681. FIG. 5A shows the spring metal 61 is prepared and going to be mounted on the metal seat 682. FIG. 5B shows the spring metal 61 is mounted and fixed on the metal seat 682. The spring metal 61 has paired wing to be elastically coupled to the metal screw 52 from inside the lamp base 50.

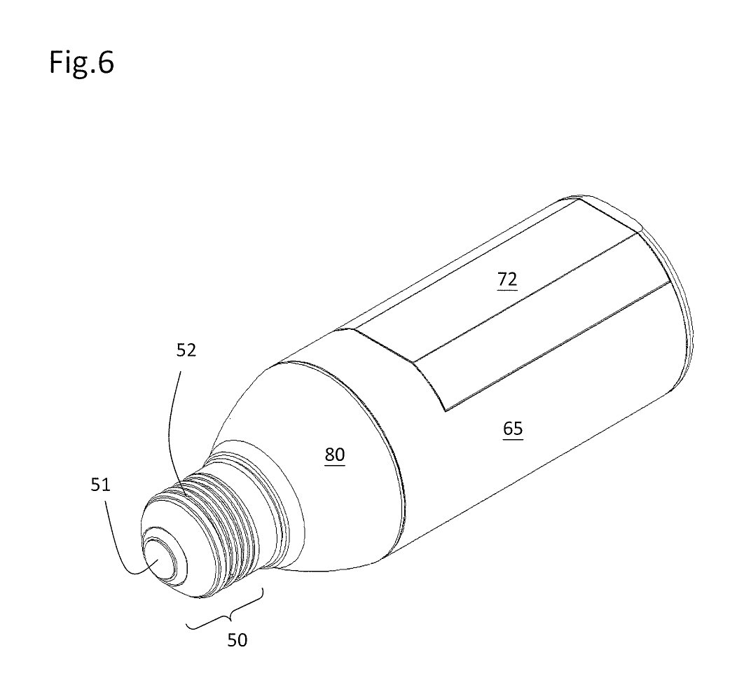

FIG. 6 shows a complete lamp according to the present invention

FIG. 6 shows that a lamp base 50 is mounted at the end of the lamp top portion of FIG. 5A˜5B.

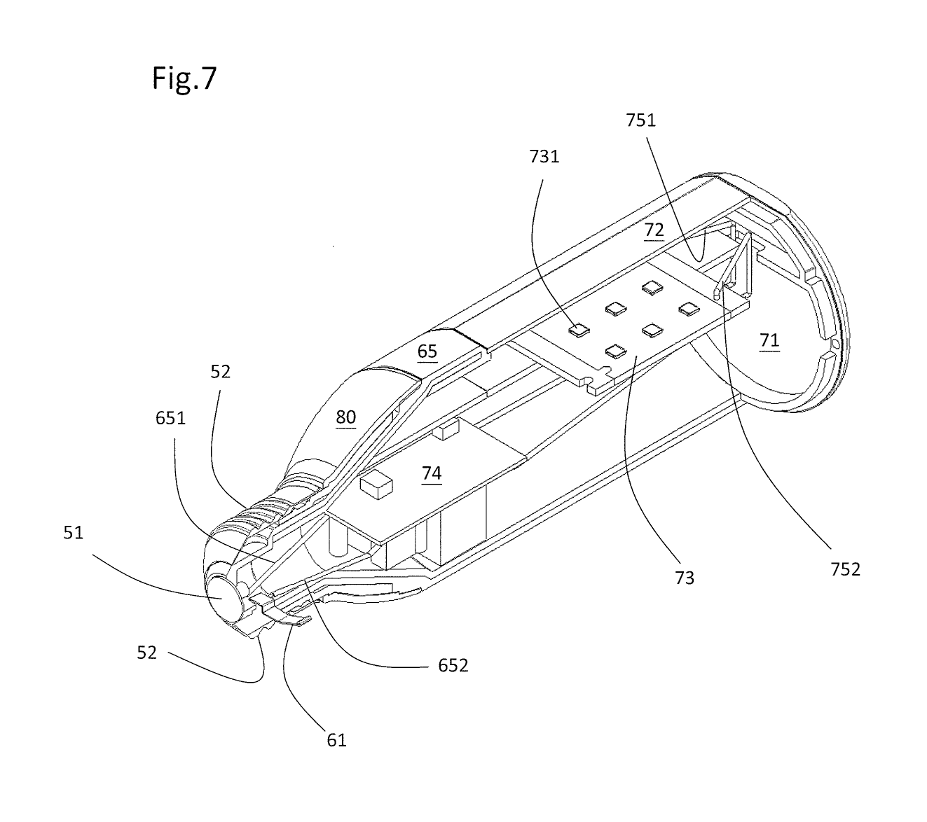

FIG. 7 is a section view of the lamp of the present invention

The spring metal 61 is electrically coupled to the metal screw 52 with its paired wing. When the top portion of the lamp is rotated, the spring metal 61 is rotating accordingly and contacts elastically against the outer screw 52

While several embodiments have been described by way of example, it will be apparent to those skilled in the art that various modifications may be configured without departing from the spirit of the present invention. Such modifications are all within the scope of the present invention, as defined by the appended claims.

What is claimed is:

1. A rotatable bulb, comprising:
a plastic housing;
a tapered end extended from the plastic housing;
a neck tube extended from the tapered end;
an axis tube extended from the neck tube;
an inner trumpet, rotatably mounted on the tapered end;
an inner screw, extended from the inner trumpet;
a spring metal, configured on the axis tube;
an outer trumpet, fixed to the plastic housing, holding the inner trumpet and rendering the inner trumpet to be freely rotatable with reference to the plastic housing;
a lamp base, having a bottom metal and a metal screw, mechanically coupled to the inner screw at an inner higher position; and wherein
the spring metal, being electrically and rotatably coupled to the metal screw at an inner lower position.

2. A rotatable bulb as claimed in claim 1, further comprising:
a metal tube, having a flat metal and a curved metal;
a hollow space, enclosed by the flat metal and the curved metal;
a single side illumination panel, configured on a top surface of the flat metal; and
the plastic housing, wrapping over the outside surface of the curved metal.

3. A rotatable bulb as claimed in claim 1, comprising:
a stopper bump, configured on a ring fringe of the inner trumpet; and
a position bump, configured on a top surface of the tapered end, configured rotatably with reference to the stopper bump.

4. A rotatable bulb as claimed in claim 2, further comprising:
a control unit, housed in the hollow space; electrically coupled to the illumination panel at one end; and electrically coupled to the spring metal and the bottom metal at the other end.

5. A rotatable bulb as claimed in claim 2, further comprising:
a light cover, configured on a top of the illumination panel.

6. A rotatable bulb as claimed in claim 5, further comprising:
an end cover, configured on an open end of the hollow space.

7. A rotatable bulb as claimed in claim 2, further comprising:
an LED matrix, configured on a top surface of the illumination panel.
